(19) United States
(12) Patent Application Publication
(10) Pub. No.: US 2008/0055934 A1
(43) Pub. Date: Mar. 6, 2008

(54) OPTICAL SHEET AND ILLUMINATION DEVICE AND FLAT PANEL DISPLAY UTILIZING THE SAME

(75) Inventors: Kimitoshi Nagao, Minami-Ashigara-shi (JP); Aya Mochizuki, Fujinomiya-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/849,729

(22) Filed: Sep. 4, 2007

(30) Foreign Application Priority Data
Sep. 4, 2006 (JP) 2006-238655

(51) Int. Cl. F21V 7/04

(52) U.S. Cl. 362/620

(57) ABSTRACT

An optical sheet allowing light which has entered the sheet through a sheet back surface to exit the sheet through a sheet front surface on which a prism portion is provided, includes an optical function part provided on a sheet end face extending between a circumferential edge of the sheet back surface and a circumferential edge of the sheet front surface for preventing leakage light from exiting the sheet through the sheet end face to return the light back into the sheet.

### FIELD OF THE INVENTION

The present invention relates to an optical sheet having a prism portion formed on a front surface of the sheet and an illumination device and a flat panel display utilizing the sheet. For example, the invention is preferably applied to flat panel televisions, portable telephones, digital cameras, car navigation systems, mobile PCs, PDAs, notebook type and desktop computers, and cash dispenser terminals at banks.

### BACKGROUND OF THE INVENTION

In flat panel displays utilizing a liquid crystal display panel according to the related art, in order to achieve high luminance through improvement in utilization of light, a configuration is employed, in which a diffusing sheet is provided on a light guide for a backlight. The configuration further includes one or two prism sheets which are optical sheets in the form of triangular rooftops. For example, a prism sheet 1 disclosed in JP-A-2004-326127 (corresponding to U.S. Pat. No. 4,906,070) has a structural surface (a prism portion 5) on one side (sheet front surface) 3 thereof and a smooth surface on another side (sheet back surface) 7 thereof opposite to the prism portion 5 as shown in FIG. 11, and the sheet is formed from an appropriate transparent material. The prism portion 5 is constituted by a linear array of very small prisms 5c each having two equal sides which are substantially perpendicular to each other, the prisms being arranged side by side to form a plurality of protrusions 5a and grooves 5b.

### SUMMARY OF THE INVENTION

Light exiting the prism sheet 1 includes not only required components exiting in the forward direction the prism surface faces but also components of low necessity exiting in a direction parallel to the prism surface. In particular, light also leaks from a sheet end face (section) 9 of the prism sheet, which results in undesirable characteristics from the viewpoint of utilization of light. As shown in FIG. 11, light rays L0, L1, and L2 passing through a point A in a base 1a of the prism sheet 1 and traveling at angles nearly parallel (substantially parallel) to sheet surfaces are dissipated out of the sheet through the sheet end face 9. Similar leakage of light is observed on various types of optical sheets including diffusing sheets.

The invention was conceived taking the above-described situation into consideration, and it is an object of the invention to provide an optical sheet in which high utilization of light can be achieved by mitigating one of undesirable characteristics of prism sheets according to the related art, i.e., waste of light attributable to leakage and dissipation of light through an end face (section) of a prism sheet. The invention also provides an illumination device and a flat panel display in which such an optical sheet is used to achieve high luminance on a light exiting side thereof or to reduce power consumption of light sources.

The above-described object of the invention is achieved by configurations as described below.

(1) The invention provides an optical sheet allowing light which has entered the sheet through a sheet back surface to exit the sheet through a sheet front surface on which a prism portion is formed. The optical sheet is characterized in that it includes an optical function part provided on a sheet end face extending between a circumferential edge of the sheet back surface and a circumferential edge of the sheet front surface for preventing leakage light from exiting the sheet through the sheet end face to return the light back into the sheet.

In this optical sheet, the optical function part returns light back into the sheet to reuse the light which is otherwise dissipated out of the sheet through the sheet end face, and the light can therefore exit the front surface. When luminance is kept unchanged, the sheet makes it possible to reduce the emission intensity of light sources or to reduce the number of light sources.

(2) The invention provides an optical sheet according to the item (1), characterized in that the optical function part reflects the leakage light to prevent it from exiting.

In this optical sheet, the optical function part provided at the sheet end face constitutes a mirror reflection layer. As a result, leakage light from the sheet end face is reflected by the mirror reflection layer and returned back into the sheet. Such return light significantly increases light rays traveling in the sheet substantially in parallel with a sheet surface. Such light rays are repeatedly reflected to exit the sheet front surface eventually, and the utilization of light is thus improved to achieve an improvement in frontal luminance.

(3) The invention provides an optical sheet according to the item (1), characterized in that the optical function part causes diffuse reflection of the leakage light to prevent it from exiting.

In this optical sheet, the optical function part provided at the sheet end face constitutes a light diffusing layer. As a result, leakage light from the sheet end face is subjected to diffuse reflection and returned back into the sheet. The return light significantly increases light rays traveling in the sheet substantially in parallel with a sheet surface. Such light rays are repeatedly reflected to exit the sheet front surface eventually, and the utilization of light is thus improved to achieve an improvement in frontal luminance.

(4) The invention provides an optical sheet according to any of the items (1) to (3), characterized in that the sheet end face is an inclined surface which meets a sheet surface of the optical sheet at an included angle of 90° or less.

When light reaches the sheet end face after traveling in this optical sheet along the sheet surface, the angle of the light is changed by the inclined surface to return the light back into the sheet. The light is thus prevented from being transmitted and dissipated out of the sheet, and it is repeatedly transmitted, refracted and reflected in the sheet, which increases the quantity of light exiting the front surface.

(5) The invention provides an optical sheet according to the item (4), characterized in that the inclined surface is constituted by a plurality of inclined surfaces at different angles of inclination.

When light inclined with reference to the sheet front surface is reflected at the sheet end face to cause it to exit the sheet front surface eventually, light at a wider range of angles of inclination with reference to the sheet front surface can be efficiently caused to exit the sheet front surface.

The invention provides an optical sheet according to any of the items (1) to (3), characterized in that the included angle at which the sheet end face meets a sheet surface of the optical sheet is within the range of 90° plus and minus 20°.

This optical sheet was conceived based on the finding that end face angles of 85° and 90° of the sheet end face result in substantially the same luminous intensity on the front surface and that the luminous intensity is slightly lower at an angle of 75°. Then, frontal luminous intensity having sufficiently high peaks can be maintained by setting the end face angle within the range of 90° plus and minus 20° or the range from 70° to 110°.

(7) The invention provides an illumination device including:
an optical sheet according to any of the items (1) to (6); and
a light source provided to face the sheet back surface of the optical sheet.

In this illumination device, when light which has entered the sheet through the sheet back surface is about to leak out of the sheet from the sheet end face, the light is prevented from exiting by the optical function part provided at the sheet end face and returned back into the sheet as return light.

The invention provides a flat panel display including:
an illumination device according to the item (7); and
a liquid crystal display panel provided to face the sheet front surface of the optical sheet in parallel with the same.

In this flat panel display, a backlight source of the liquid crystal panel is constituted by the illumination device which utilizes light with high efficiency, and the display is therefore capable of display with luminance higher than that of a flat panel display according to the related art when power consumption is the same. When the display is required only to have the same display luminance as in the related art, it is possible to reduce the emission intensity of light sources or to reduce the number of light sources.

In an optical sheet according to the invention, an optical function part for preventing leakage light from exiting the sheet through a sheet end face extending between a circumferential edge of a sheet back surface and a circumferential edge of a sheet front surface is provided at the sheet end face. It is therefore possible to return light from the sheet end face back into the sheet instead of allowing it to be dissipated out of the sheet, and the light can be reused and caused to exit the front surface. Thus, frontal luminance can be improved. When luminance is kept unchanged, it is possible to reduce the emission intensity of light sources or to reduce the number of light sources, which allows power consumption to be reduced when the intensity of illumination is unchanged.

The illumination device according to the invention includes an optical sheet according to any of the items (1) to (6) and a light source provided to face the sheet back surface. Therefore, when light from the light source which has entered the sheet through the sheet back surface is about to leak out of the sheet through the sheet end face, the light is prevented from exiting by the optical function part provided at the sheet end face and returned back into the sheet as return light. As a result, the number of light rays exiting the prism portion in the forward direction is increased, and improved frontal luminance can therefore be achieved with the same power consumption as in the related art.

A flat panel display according to the invention includes the illumination device according to the item (7) and a liquid crystal display panel provided to face the sheet front surface of the optical sheet in parallel with the same. Therefore, a light source for a backlight of the liquid crystal display panel can be constituted by an illumination device that achieves high utilization of light, which allows display at higher luminance with the same level of power consumption as that of flat panel displays in the related art. When only the same display luminance as in the related art is to be achieved, it is possible to reduce the emission intensity of light sources or to reduce the number of light sources, which allows power consumption to be reduced.

### BRIEF DESCRIPTION OF THE DRAWINGS

FIG. 1 is a sectional view of a flat panel display according to the invention.

FIG. 2 is a sectional view of the prism sheet shown in FIG. 1.

FIGS. 3A and 3B are enlarged sectional views of major parts of the optical function part shown in FIG. 2, the optical function part being a light diffusing layer constituted by a coated surface in FIG. 3A and a light diffusing layer constituted by a surface having microscopic irregularities in FIG. 3B.

FIG. 4 is an illustration schematically representing a method of forming a mirror reflection layer.

FIG. 5 is an illustration schematically representing a method of forming a sheet end face of a roll type sheet.

FIG. 6 is a sectional view of a second embodiment of the invention in which a sheet end face is inclined.

FIGS. 7A, 7B, and 7C are illustrations of modifications of a sheet end face, FIG. 7A showing a sheet end face having a plurality of angles of inclination different from each other, FIG. 7B showing a sheet end face constituted by a curved surface, FIG. 7C showing a sheet end face constituted by a combination of inclined surfaces and a curved surface.

FIG. 8 is a graph representing the distributions of the angles of light rays in prism sheets obtained through a simulation.

FIG. 9 is a graph representing the distributions of intensities of light exiting the prism sheets obtained through a simulation.

FIG. 10 is a graph representing the distribution of luminous intensities obtained through a simulation in which the angle of inclination of a sheet end face was varied.

FIG. 11 is a sectional view of a prism sheet according to the related art.

### DESCRIPTION OF REFERENCE NUMERALS AND SIGNS

11: liquid crystal display panel

13: cathode ray tube (light source)

19: sheet back surface

21: sheet substrate surface

22: sheet front surface

23: prism portion

29: sheet end face

31: mirror reflection layer (optical function part)

33: light diffusing layer (optical function part)

41: inclined surface (optical function part)

100, 100A: prism sheet (optical sheet)

200: illumination device

300: flat panel display

θ: included angle

### DETAILED DESCRIPTION OF THE INVENTION

Preferred embodiments of an optical sheet and an illumination device and a flat panel display utilizing the same will now be described with reference to the drawings.

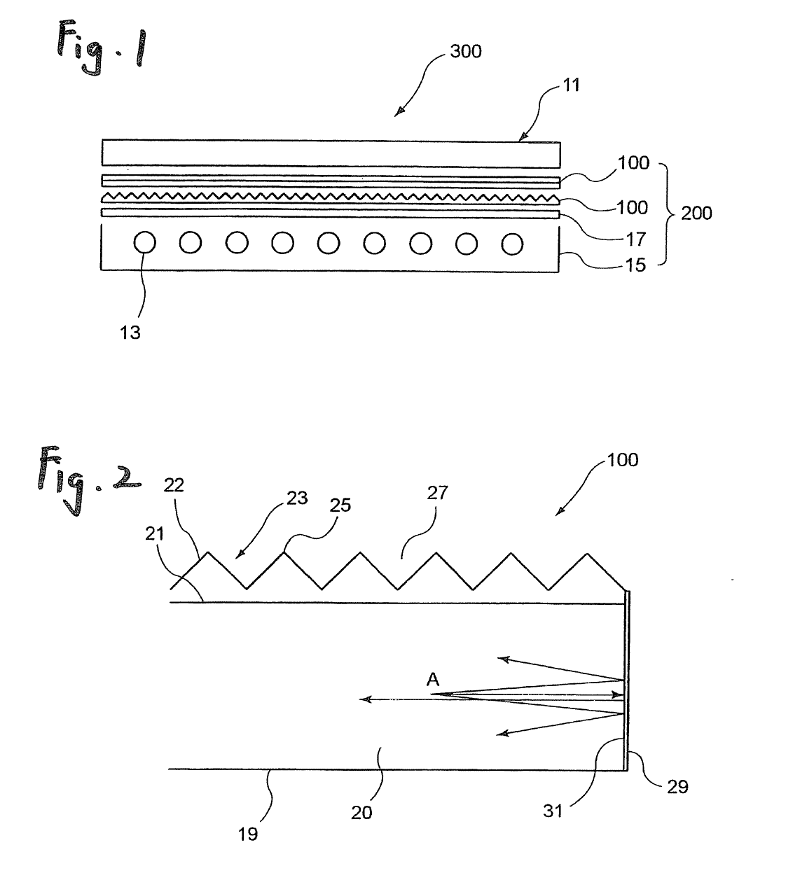

FIG. 1 is a sectional view of a flat panel display according to the invention, and FIG. 2 is a sectional view of the prism sheet shown in FIG. 1.

A flat panel display 300 according to the invention includes an illumination device 200 provided such that a light-emitting surface of the device faces a back surface of a liquid crystal display panel 11. The illumination device 200 includes a light source unit 15 provided by arranging a plurality of linear cathode ray tubes 13 serving as light sources side by side, a light diffusing sheet 17 provided on a light exit side of the light source unit 15, and two prism sheets 100 which are optical sheets provided on a light exit side of the light diffusing sheet 17.

Since the two prism sheets 100 are identical, the description will address only one of the sheets. A prism sheet 100 allows light emitted from the illumination device 200 to enter the sheet itself through a sheet back surface 19 that is shown in FIG. 2 and allows the light to exit from a sheet front surface 22. The prism sheet 100 is primarily constituted by a sheet substrate portion 20 and a prism portion 30, and the prism portion 23 is formed on a sheet substrate surface 21. The prism portion 23 has a plurality of prisms 25 in the form of convex strips having a triangular sectional shape arranged in parallel with each other. The portion therefore has an irregular surface constituted by convex strips and V-shaped grooves 27 which are alternately arranged. The two prism sheets 100 are disposed in such relative orientation that the respective groups of prisms 25 are orthogonal to each other.

An optical function part is provided on a sheet end face 29 of the prism sheet 100. A prism end face 29 is an end face extending between a circumferential edge of the sheet back surface 19 and a circumferential edge of the sheet front surface 22. In the present embodiment, the optical function part is constituted by a mirror reflection layer 31 which reflects light leaking through the sheet end face 29 to prevent it from exiting the sheet. For example, let us discuss light passing through a point A as shown in FIG. 2 on an assumption that the optical function part is constituted by the mirror reflection surface. Then, the mirror reflection surface 31 reflects components of the light which can otherwise leak through the sheet end face 29 to return them back into the sheet. Such return light significantly increases light rays existing in the sheet substantially in parallel with the sheet surfaces. The light rays undergo repeated reflections and eventually exit the sheet front surface 22, which makes it possible to achieve improved utilization of light and improved frontal luminance.

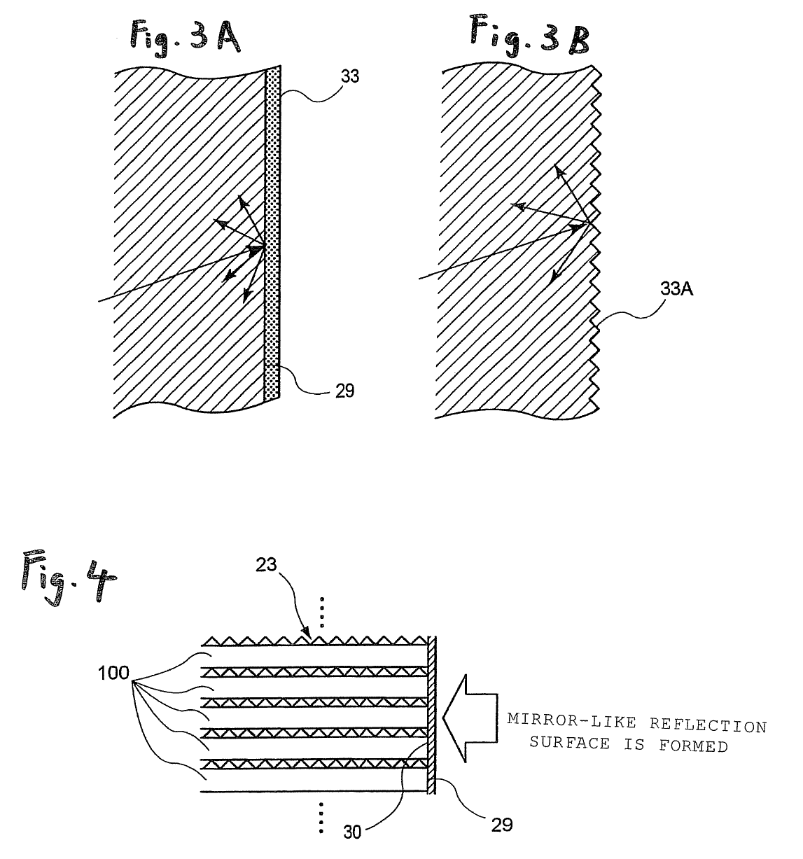

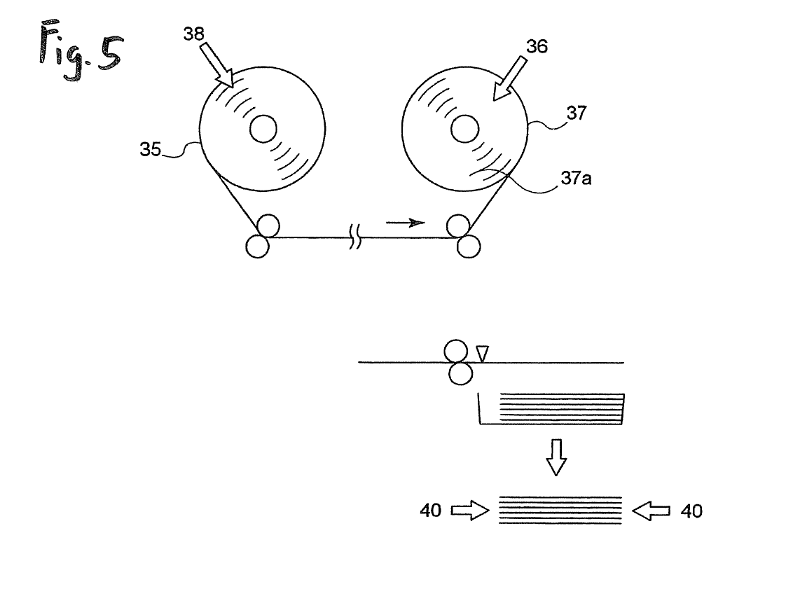

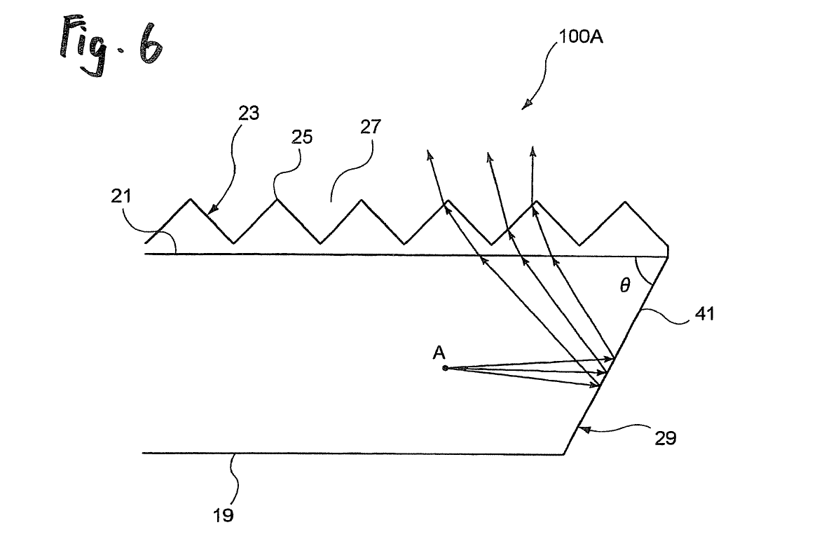

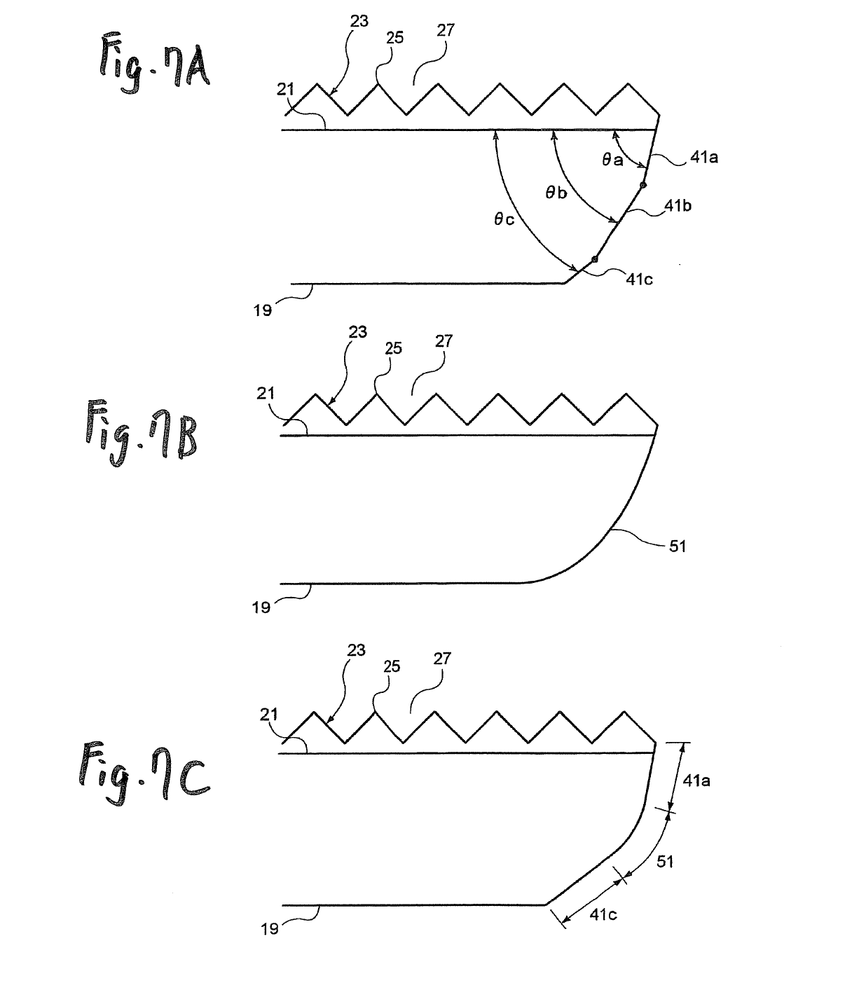

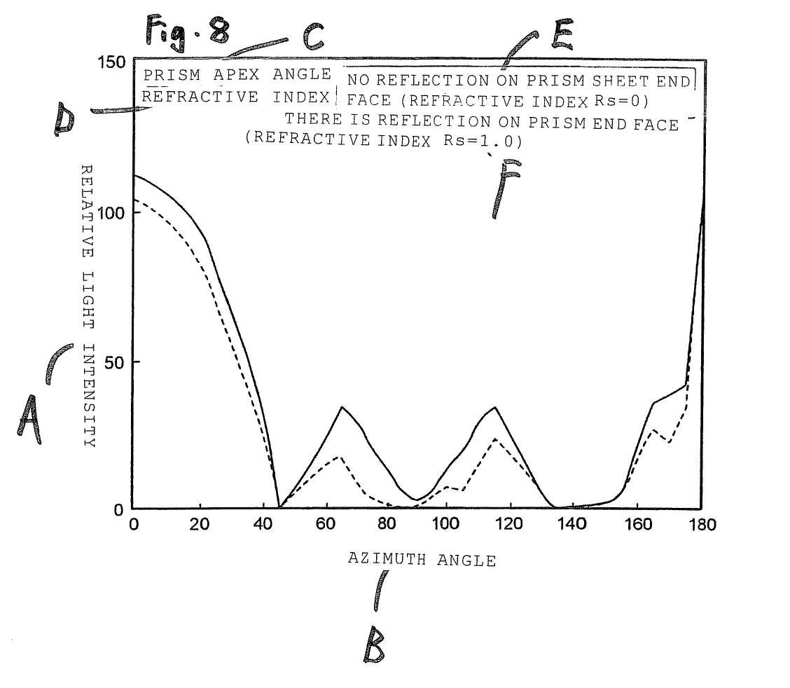

FIGS. 3A and 3B are enlarged sectional views of the optical function part shown in FIG. 2, the optical function part being a light diffusing layer constituted by a coated surface in FIG. 3A and a light diffusing layer constituted by a surface having microscopic irregularities in FIG. 3B.

The optical function part may be a light diffusing layer 33 which prevents light from exiting the sheet end face 29 by causing diffuse reflection of the light which can otherwise leak out through the sheet end face. The light diffusing layer 33 may be a layer formed on the sheet end face 29 shown in FIG. 3A, and it may alternatively be a layer 33A having microscopic irregularities formed by processing the sheet end face 29 directly as shown in FIG. 3B. When the optical function part is a light diffusing layer 33, the light diffusing layer 33 causes diffuse reflection of light which can otherwise leak out through the sheet end face 29, and the light is thereby returned back into the sheet. The return light significantly increases light rays existing in the sheet in parallel with the sheet surfaces. The light rays undergo repeated reflections and eventually exit the sheet front surface 22, which makes it possible to achieve improved utilization of light and improved frontal luminance.

FIG. 4 is an illustration schematically representing a method of forming the mirror reflection layer, and FIG. 5 is an illustration schematically representing a method of forming a sheet end face of a sheet in the form of a roll.

As shown in FIG. 4, the mirror reflection layer 31 may be formed by applying metal paste 30 obtained by dispersing metal powder in a solvent to an end face 29 of a sheet provided by stacking two or more prism sheets 100 (only one prism sheet may alternatively be used) and drying the paste. The layer may alternatively be formed by spraying metal paste obtained by dispersing metal powder in a solvent onto the above-described sheet end face 29. Alternatively, the layer may be formed by vacuum-depositing metal powder on the above-described sheet end face 29. Still alternatively, the layer may be formed by sputtering metal powder onto the above-described sheet end face 29.

The mirror reflection layer 31 and the light diffusing layer 33 may be formed by a process in which an optical sheet is fabricated using a material roll 35 and a product roll 37 and in which, for example, coating 36 is performed according to the above-described method on a roll end face 37a of the product roll 37 after the sheet is taken up. Alternatively, coating 38 may be performed according to the above-described method on the material roll 35 prior to the fabrication of the sheet, and a prism sheet 100 may be thereafter fabricated. After the roll sheet is cut, coating 40 is further performed to form mirror reflection layers 31 and light diffusing layers 33 on end faces of the cut sheets. Alternatively, the mirror reflection layers 31 may be formed on sheet end faces 29 by coating them with metal paste as described above at a handling step that is arbitrarily provided.

In particular, the mirror reflection layers 31 or light diffusing layers 33 may be formed on the sheet end faces 29 when the sheets are in the rolled state according to any of the above-described methods if the sheet end faces 29 are vertical. However, when the sheet end faces 29 constitute a surface at an angle offset from the vertical, it is difficult to form the layers according to the above-described methods because each sheet forms an irregularity at the end face of the roll when the sheets are in the rolled state. Therefore, the mirror reflection layers 31 or light diffusing layers 33 may alternatively be formed by immersing the sheet end faces 29 in a solution for forming the layers while keeping the sheets vertical at a step for conveying the sheets in an unrolled state (at a roll conveying path which is not shown in FIG. 5). In this case, the mirror reflection layers 31 or light diffusing layers 33 are formed not only on the sheet end faces 29 but also on sheet back surfaces 19 and prism portions 23. However, there is no problem because sheet end portions of an optical sheet are areas where no light enters or exits the sheet.

In the case of the prism sheet 100 having such optical function part on the sheet end face 29 thereof, light is returned back into the sheet by the optical function part at the sheet end face 29 where the light will otherwise be dissipated out of the sheet. Therefore, the light can be reused and can exit the sheet through the front surface thereof. When luminance is kept constant, the emission intensity of light sources or the number of the light sources can be reduced.

A second embodiment of an optical sheet according to the invention will now be described.

FIG. 6 is a sectional view of the second embodiment in which a sheet end face is inclined.

A sheet end face 29 of a prism sheet 100A according to the present embodiment is constituted by an inclined surface 41 which meets sheet surfaces (a sheet back surface 19 and a sheet substrate surface 21 in the present embodiment) at an included angle (hereinafter also referred to as “end face angle”) θ of 90° or less to the sheet surfaces.

As shown in FIG. 6, the sheet end face 29 of the prism sheet 100A is constituted by the inclined surface 41 which is inclined from the perpendicularity to the sheet substrate surface 21. As a result, when light rays L0, L1 and L2 traveling in the sheet in a lateral direction along the sheet substrate surface 21 reach the sheet end face 29, the light rays L0, L1, and L2 are reflected by the inclined surface 41. Thus, the light rays are returned back into the prism sheet 100A at different angles and are therefore prevented from being transmitted and dissipated out of the sheet, which makes it possible to increase light rays forwardly exiting the sheet through a sheet front surface 23.

That is, when light traveling in the sheet along the sheet surfaces reaches the sheet end face 29, the angle of the light is changed by the inclined surface 41 to return the light back into the sheet, thereby preventing the light from being transmitted and dissipated out of the sheet. The light is then repeatedly transmitted, refracted, and reflected in the sheet to increase the quantity of light exiting the sheet front surface 22.

The inclined surface 41 (an end face of a transparent substrate constituted by plastic or a film) of the prism sheet 100A is preferably a smooth surface which can cause mirror reflection (a mirror reflection layer 31). The inclined surface 41 may be a light diffusing layer 33 having diffusing properties. The included angle θ of the inclined surface 41 is set at an appropriate and optimum value according to the thickness and size the optical sheet (the sheet size being the length of a side of the sheet or the surface area of the same).

Preferably, the sheet end face 29 meets sheet surfaces (the sheet back surface 19 and the sheet substrate surface 21 in the present embodiment) of the optical sheet 100 at an included angle within the range of 90° plus and minus 20° or the range from 70° to 110°. The reason is that frontal luminous intensity is substantially the same when the included angle θ of the sheet end face 29 is 85° and 90° and is slightly lower when the angle is 75°. Frontal luminous intensity having high peaks can be maintained by keeping the end face angle within the range of 90° plus and minus 20°.

The prism sheet 100A returns light which has been transmitted and dissipated lost out of the sheet according to the related art, back into the sheet. The light returned into the sheet travels in the sheet in the opposite direction. Light rays in parallel with the sheet substrate surface 21 travel toward another sheet end face 29 on the opposite side. Light rays which are offset from the parallelism impinge upon a sheet back surface 19 and a prism portion 23 however small the offsets are. The light rays are repeatedly refracted, reflected, and transmitted, and the quantity of light exiting the prism portion 23 is thereby increased.

In an idealistic system in which the substrate of the prism sheet 100A is completely flat and in which the sheet end faces 29 are perfectly vertical, light rays traveling in perfect parallelism with the sheet substrate surface 21 are reflected by the sheet end face 29, and they reach the sheet end face 29 on the opposite side to be reflected repeatedly. The percentage of the light rays in perfect parallelism is small, and light rays offset from the parallelism impinge upon the sheet back surface 19 and the prism portion 23 as a result of reflection at the end face however small the offsets are.

In practice, there are microscopic curves and irregularities on the surface of the prism sheet 100A. The end faces also have an angular offset from the vertical, and there are also curves and irregularities on the sheet end faces 29. Therefore, most of light rays reflected by the sheet end faces 29 impinge upon either sheet back surface 19 or prism portion 23. When the sheet end face 29 is formed to define an included angle θ that is different from the vertical, light rays traveling in the sheet substantially in parallel with the same are reflected by the sheet end face 29 with their angles changed, and the light rays then impinge upon the sheet back surface 19 and the prism portion 23 to be refracted, reflected, and transmitted.

For example, let us assume that the sheet back surface 19 is a surface inclined from the perpendicularity to the sheet substrate surface 21 as shown in FIG. 6. Then, when light rays L0, L1, and L2 traveling in the sheet in a lateral direction along the sheet substrate surface 21 reach the sheet end face 29, the light rays L0, l1, and L2 are reflected by the sheet end face 29 and are returned back into the sheet with their angles changed. It is therefore possible to prevent the light rays from being transmitted and dissipated out of the sheet and to increase light rays exiting the sheet forward through the prism portion 23 consequently.

The inclined surface 41 of the prism sheet 100A is a smooth surface which allows mirror reflection to take place. Although the inclined surface 41 is preferably constituted by a smooth mirror reflection layer 31, the purpose of preventing transmission and dissipation of light from the sheet end face 29 can be achieved by a surface having irregularities as long as the surface reflects light. Similarly, the inclined surface may be a light diffusing layer 33 having diffusing properties.

FIGS. 7A, 7B, and 7C are illustrations of modifications of a sheet end face, FIG. 7A showing a sheet end face having a plurality of angles of inclination different from each other, FIG. 7B showing a sheet end face constituted by a curved surface, FIG. 7C showing a sheet end face constituted by a combination of inclined surfaces and a curved surface.

The sheet end face 29 of the prism sheet 100A may be constituted by a plurality of inclined surfaces 41a, 41b, and 41c at different angles of inclination θa, θb, and θc as shown in FIG. 7A. That is, the sheet end face is not limited to one flat surface, and it may be a plurality of flat surfaces at different angles, a curved surface 51 as shown in FIG. 7B, or a composite surface that is a combination of a curved surface 51 and various inclined surfaces 41a and 41c as shown in FIG. 7C. In the last case, the number of inclined surfaces 41 is preferably in the range from 2 to 20. The reason is that inclined surfaces can only provide optical performance substantially equivalent to that of a curved surface while requiring a great deal of time and labor for processing when the number of the inclined surfaces is too great.

With a prism sheet 100A formed with a sheet end faces having a plurality of angles of inclination different from each other as described above, when light at a certain inclination to the sheet substrate surface 21 is reflected at the sheet end face 29 to eventually exit the sheet front surface 22, the light can be reflected at a wider range of angles of inclination to the sheet front surface 22 and can therefore exit the sheet front surface 22 with higher efficiency.

Referring now to means for inclining the sheet end face 29 of the prism sheet 100A at an angle other than 90° or the method of forming the sheet end face 29 at an arbitrary angle to the sheet substrate surface 21 other than perpendicularity, an oblique cutting process may be employed, which is performed at different cutting angles with cutting means that is commonly used.

Even when the sheet end face is set at an angle of inclination other than perpendicularity as described above, the dissipation of light out of the sheet can be reliably prevented by providing the mirror reflection layer 31 or the light diffusing layer 33 on the sheet end face 29.

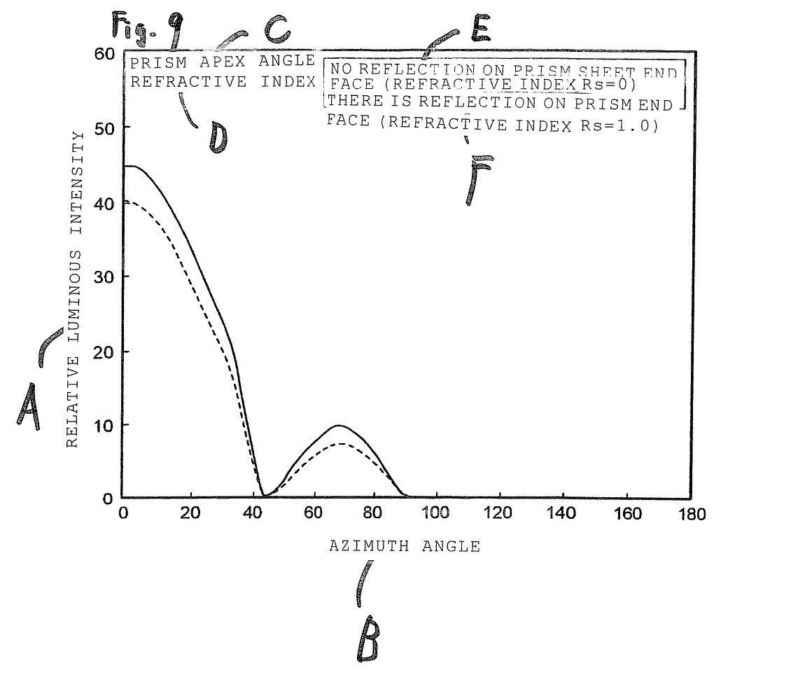

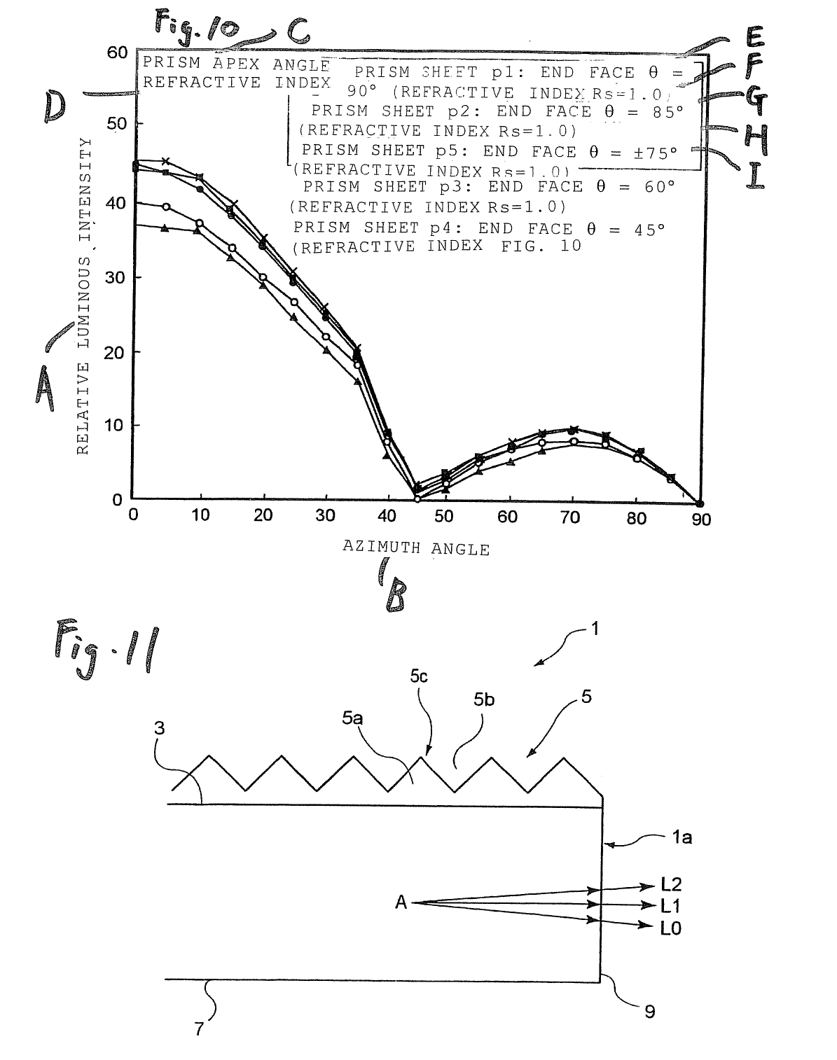

FIG. 8 is a graph representing the distributions of the angles of light rays in prism sheets obtained through a simulation. FIG. 9 is a graph representing the distributions of intensities of light exiting the prism sheets obtained through a simulation. FIG. 10 is a graph representing the distribution of luminous intensities obtained through a simulation in which the angle of inclination of a sheet end face was varied.

An analysis was carried out on the effect of a prism sheet according to the embodiment by way of example. Referring to FIG. 8, the distribution of the angles of light rays in a prism sheet according to the related art having no provision for mirror reflection at an end face shows that there are light rays at angles of 65° and 115° on both sides of an angle θₚ=90° which represents parallelism with sheet surfaces, as indicated by the broken line. When the sheet end face 29 is constituted by a mirror reflection surface according to the invention, light rays at angles of θₚ=90° plus and minus 45° are reflected by the end face to be returned back into the sheet. It will be understood that the quantity of light rays at the angles of θₚ=90° plus and minus 45° is significantly increased and that the quantity of light rays at angles θₚ in the range from 0° to 45° is increased, as indicated by the solid line. The distributions of the light intensities of light exiting the prism sheet surface indicate that higher luminous intensities are achieved when there is provision for reflection at a sheet end face (indicated by the solid line) than when there is no provision for reflection at an end face (indicated by the broken line).

Referring to the result of the simulation carried out by varying the angle of the sheet end face shown in FIG. 10, curves P₁ to P₄ representing luminous intensity distributions indicate results obtained at different angles θ of the prism sheet end face, i.e., 90°, 85°, 60°, and 45°, respectively. A curve P₅ (accompanied by an angle specification of ±75°) indicates results obtained by forming the end face with two surfaces, i.e., a surface having an end face angle of 105° and a surface having an end face angle of 75°. That is, the two-surface configuration represented by the curve P₅ is a shape which bulges outward from the sheet in the form of the character “V”. FIG. 10 indicates that frontal luminous intensity is similar at the angles of 85° and 90° and slightly lower at the angle of 75° (two-surface configuration). Therefore, a preferable range of end face angles at which high frontal luminous intensity can be achieved is 90° plus and minus 20° or from 70° to 110°, and the range from 80° to 100° is more preferable.

In the above-described optical sheet, an optical function part (the mirror reflection layer 31, light diffusing layer 33, or inclined surface 41) is provided on the sheet end face 29 extending between a circumferential edge of the sheet back surface 19 and a circumferential edge of the sheet front surface 22 to prevent light from leaking out of the sheet through the sheet end face and to return the light back into the sheet. Thus, the light which can be otherwise dissipated out of the sheet through the sheet end face 29 can be reused and caused to exit the front of the sheet, which makes it possible to achieve improved frontal luminance. When luminance is kept unchanged, it is possible to reduce the emission intensity of light sources or to reduce the number of light sources. Thus, power consumption can be reduced.

The illumination device 200 includes the optical sheet and a light source disposed to face the sheet back surface 19 of the optical sheet. When light emitted from the light source enters the sheet from a sheet back surface 19 and the light which has entered the sheet is about to leak out through the sheet end face 29, the light is prevented from exiting by the optical function part provided on the sheet end face 29 and returned back into the sheet as return light. As a result, the quantity of light rays exiting forward through the prism portion 23 is increased, which allows improved frontal luminance to be achieved with the same level of power consumption as that in the related art.

The flat panel display 300 includes the illumination device 200 and a liquid crystal display panel 11 disposed to face a sheet surface of the optical sheet in parallel with the same. A backlight source for the liquid crystal display panel 11 can be constituted by the illumination device 200 which achieves high utilization of light. Therefore, display at high luminance can be achieved with the same power consumption as that of a flat panel display according to the related art. When display is to be achieved with only the same luminance as in the related art, power consumption can be reduced by reducing the emission intensity of light sources or reducing the number of light sources.

This application is based on Japanese Patent application JP 2006-238655, filed Sep. 4, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An optical sheet allowing light which has entered the sheet through a sheet back surface to exit the sheet through a sheet front surface on which a prism portion is provided, the optical sheet comprising:
an optical function part provided on a sheet end face extending between a circumferential edge of the sheet back surface and a circumferential edge of the sheet front surface for preventing leakage light from exiting the sheet through the sheet end face to return the light back into the sheet.

2. The optical sheet according to claim 1, wherein the optical function part reflects the leakage light to prevent it from exiting.

3. The optical sheet according to claim 1, wherein the optical function part causes diffuse reflection of the leakage light to prevent it from exiting.

4. The optical sheet according to claim 1, wherein the sheet end face is an inclined surface which meets a sheet surface of the optical sheet at an included angle of 90° or less.

5. The optical sheet according to claim 2, wherein the sheet end face is an inclined surface which meets a sheet surface of the optical sheet at an included angle of 90° or less.

6. The optical sheet according to claim 3, wherein the sheet end face is an inclined surface which meets a sheet surface of the optical sheet at an included angle of 90° or less.

7. The optical sheet according to claim 4, wherein the inclined surface comprises a plurality of inclined surfaces at different angles of inclination.

8. The optical sheet according to claim 5, wherein the inclined surface comprises a plurality of inclined surfaces at different angles of inclination.

9. The optical sheet according to claim 6, wherein the inclined surface comprises a plurality of inclined surfaces at different angles of inclination.

10. The optical sheet according to claim 1, wherein the included angle at which the sheet end face meets a sheet surface of the optical sheet is within a range of 90° plus and minus 20°.

11. The optical sheet according to claim 2, wherein the included angle at which the sheet end face meets a sheet surface of the optical sheet is within a range of 90° plus and minus 20°.

12. The optical sheet according to claim 3, wherein the included angle at which the sheet end face meets a sheet surface of the optical sheet is within a range of 90° plus and minus 20°.

14. An illumination device comprising:
the optical sheet according to claim 1; and
a light source provided to face the sheet back surface of the optical sheet.

15. A flat panel display comprising:
the illumination device according to claim 14; and
a liquid crystal display panel provided to face the sheet front surface of the optical sheet in parallel with the sheet front surface.
